(19) United States
(12) Patent Application Publication
(10) Pub. No.: US 2024/0376832 A1
(43) Pub. Date: Nov. 14, 2024

(54) Dobymy Power Plant

(71) Applicant: Dobymy M Jomode Elie Getty, Union City, NJ (US)

(72) Inventor: Dobymy M Jomode Elie Getty, Union City, NJ (US)

(21) Appl. No.: 18/315,469

(22) Filed: May 10, 2023

(51) Int. Cl. F01D 15/10

(52) U.S. Cl. CPC F01D 15/10; F05D 2220/76

(57) ABSTRACT

The example medium town, for warehouse, factory, and for oil refinery.

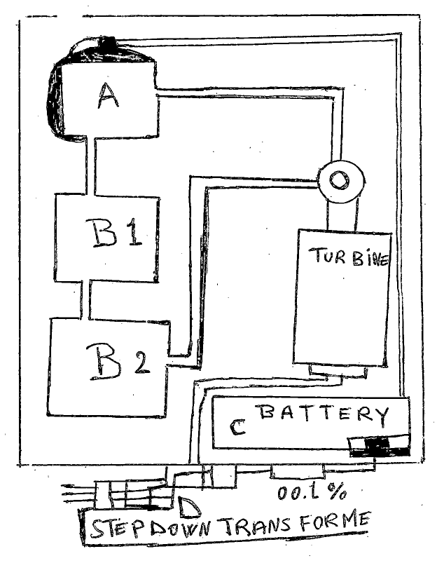

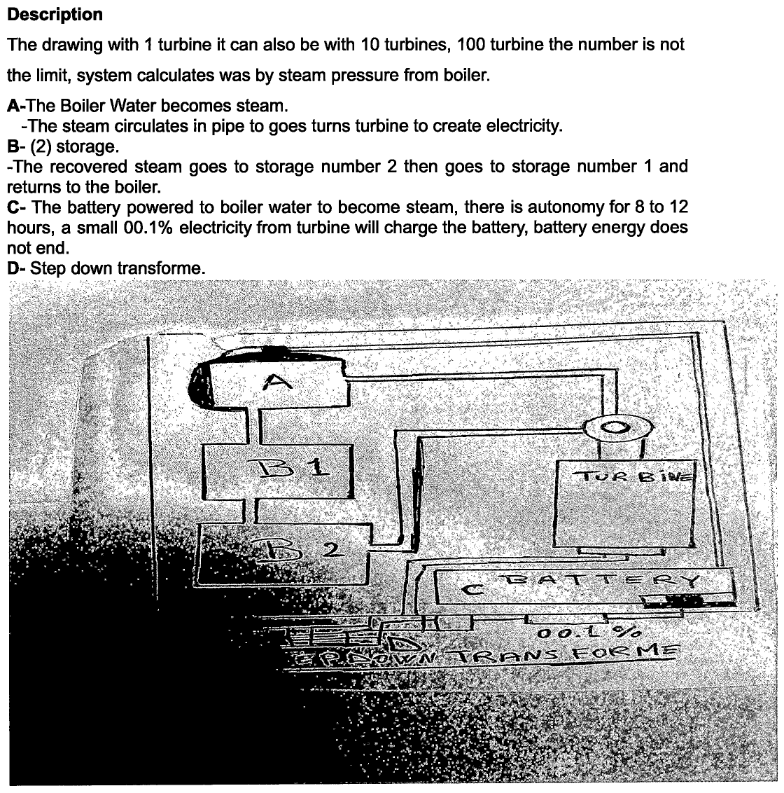

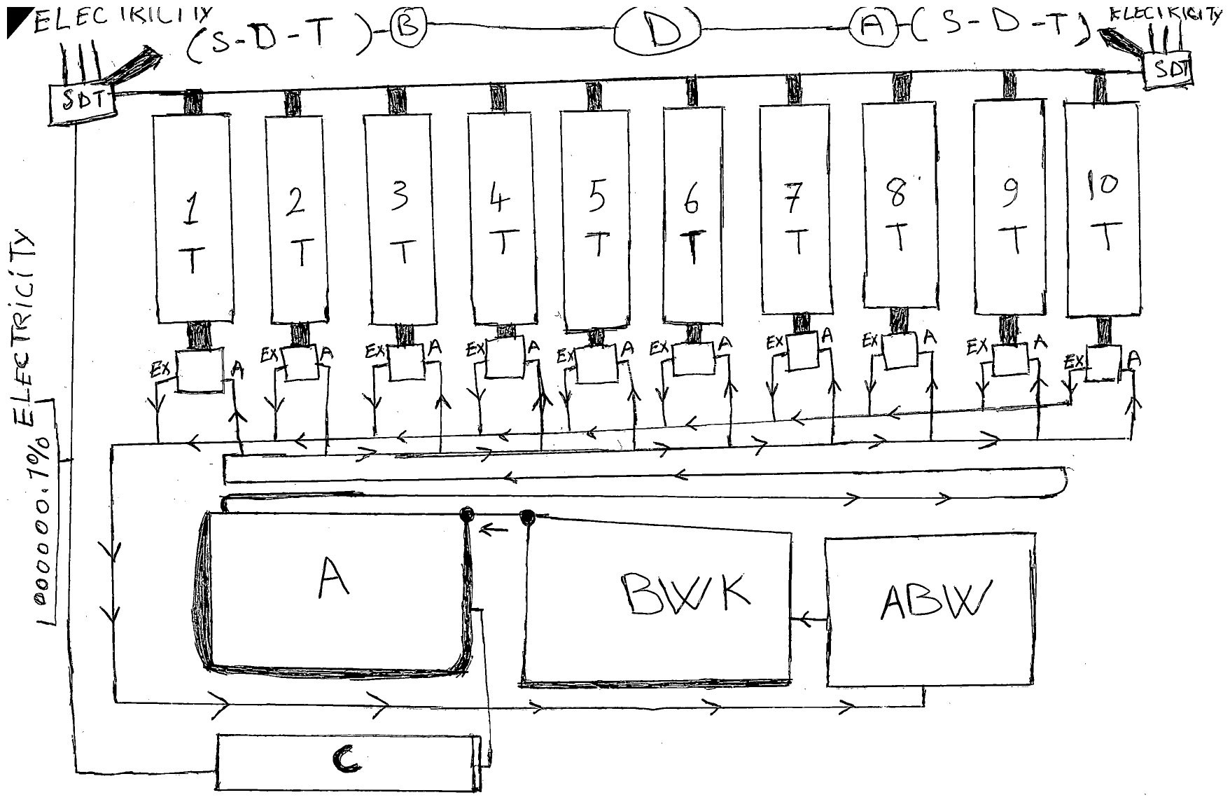

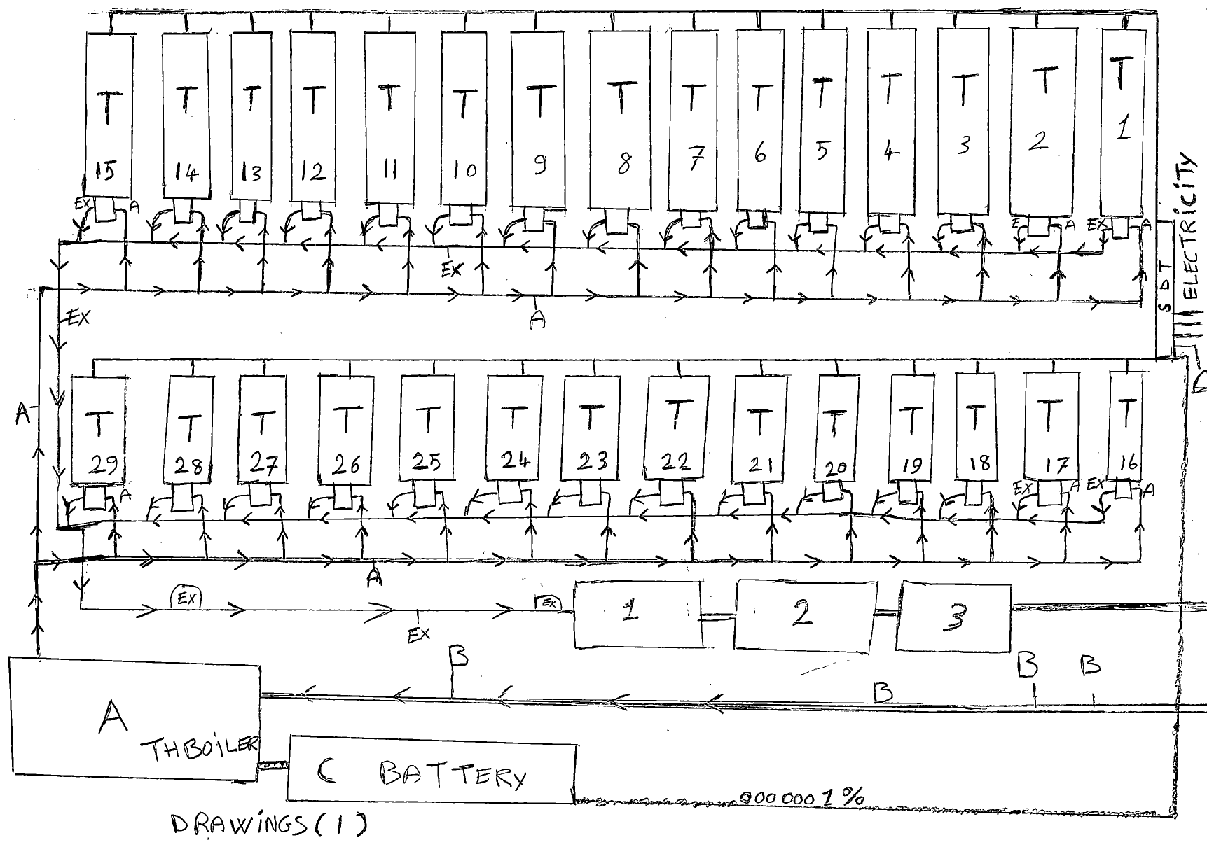

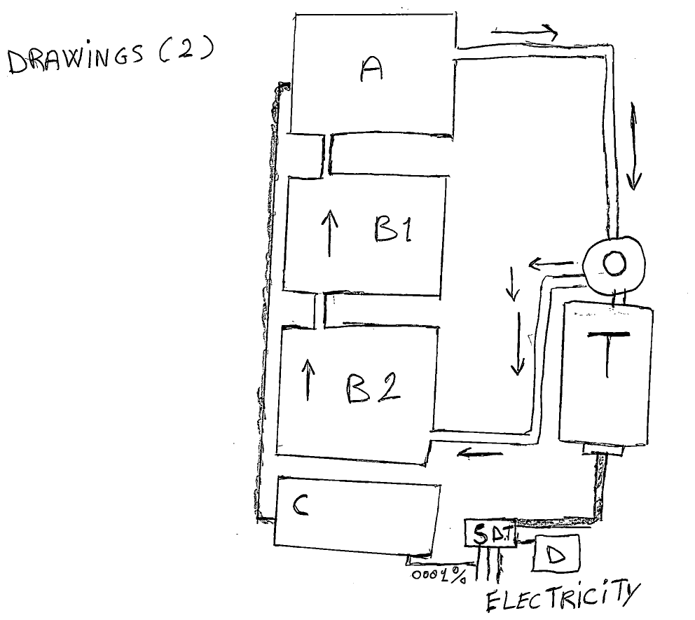

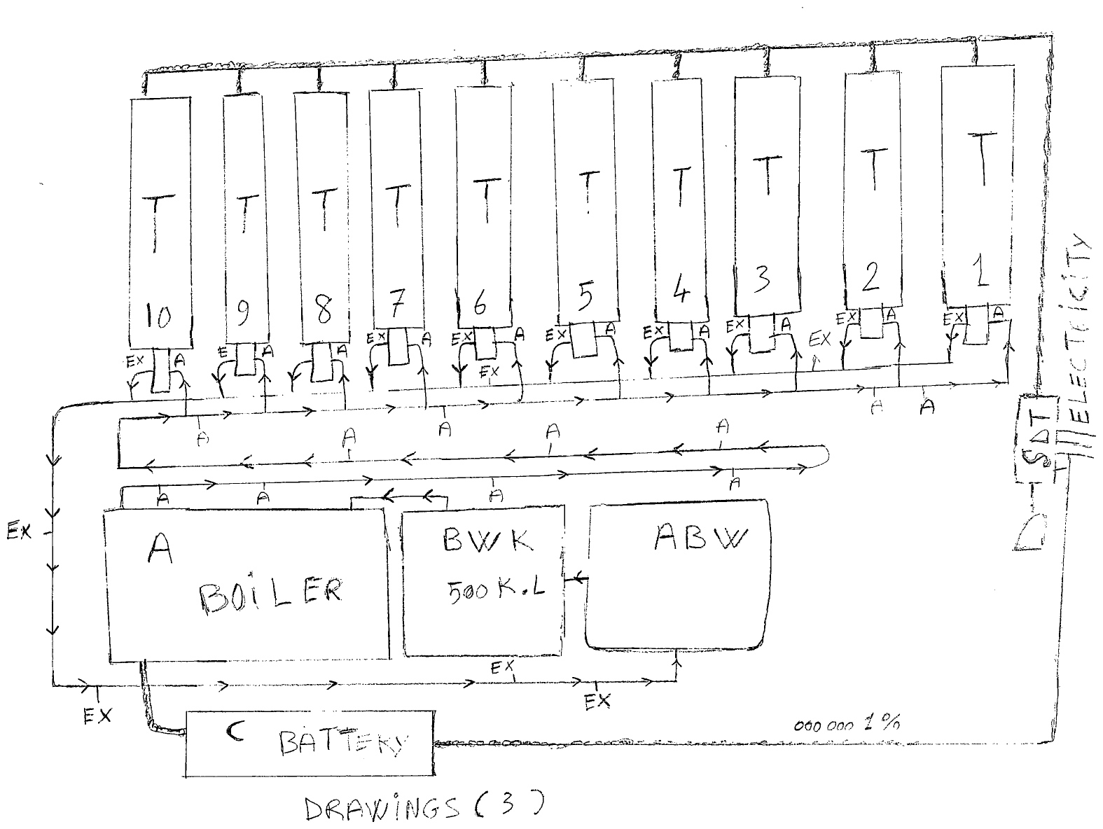

The present invention comprises methods the boiler powered with battery energy, water change to steam, a steam is moving inside pipes to operate the turbine create an electricity.

The Process with a turbine, with 10 turbines or more, the number is not the limit, system calculates was by steam pressure.

### BACKGROUND

The power plant works like a nuclear power plant, nuclear power plants operate with nuclear fuel for a lifespan generally between 3 and 5 years.

The device (rechargeable battery), as well as operation to boiler, also device control of the pressure in the pipeline, management of the speed of the turbine, thermal management of the connection between the turbine and the generator, control of tank, conversion of steam to water, the device lifespan 15 to 20 years.

The nuclear power plants operate with one a very large turbine, this invention operating small turbine, increasing the number of turbines producing a lot of electricity, which will create the electrical capacity of 3 nuclear power plants in one location.

### SUMMARY

The power plant, the battery operates a boiler, Water goes into boiler to become steam, boiler creates steam with water, or liquid transformable to steam, sea water, or river, or non-potable water, example taking water from the sea we create electricity then to consume it water.

The boiler consumes little energy but it's very powerful which will transform the water into steam in a few seconds my battery is very powerful, and light, does not heat up.

The power plant is not dangerous, 100% security and safety it is good for the environment, is cheaper and sustainability.

The power plant very easy to doing electricity everywhere in the world and in space, on moon and mars.

The power plant creates autonomous owned electricity 100% Green and very cheap electricity, for big City like New York city or Chicago, no need Electric lines (power high transmission) come from power plant at 200 miles or 2000 miles, my invention very good for environment.

Mobility power plant which creates its own energy, and zero emissions for:
car, Truck, Train, boat or Ship, Aircraft carrier, drone, aircraft, submarine, subway, all categories of agricultural vehicles, or construction.

Not Mobility power plant which creates its own energy, house, warehouse, factory, small and big city, manufacturing of green hydrogen, Oil refinery.

### DESCRIPTION OF THE DRAWINGS

1—The drawing with 29 turbines, or 100 turbine the number is not the limit, system calculates was by steam pressure from boiler.
29 Turbines Generator
45% Turbine=electricity capacity 950 MW (Mega Watt)
90% Turbine=electricity capacity 1900 MW (Mega Watt)

Each turbine has an electricity capacity control system.
A—The Boiler Water becomes steam.
   The steam circulates in pipe to goes turns turbine (Steam go in A and out, Ex)
      2 pipe which does not link and not connect
         A pipe of boiler go turn the Turbine.
         Ex, the steam pipe leaving the turbine goes to storage (Water tank 1,2,3.)

If we use sea water, I put 3 storages with filter and steam treatment turns into drinking water.

Each storage (water tank) 1 million liters.

If the water from well or river, I put in place 2 storage (Water tank), return to boiler, the system installed there will be no waste of water.

The water from the Storage to go to the boiler, do not need the pump, do not need high pressure.
B, pipe arrival of sea water or river water or well water.
C—The battery 1.4 MWh powered to boiler water to become steam, there is autonomy for 10 to 15 hours, a small 000000.1% electricity from turbine will charge the battery, battery energy does not end.
D—Step down Transformed (S-D-T) number at 4

The generating step-up transformer to transmission lines, then connects an electrical power distribution, a connects many substations step-down transformers among which one connected reduces high voltage, recharge the device.

### 2. The Drawing Mobile, and Miniature.

A—The Boiler Water becomes steam.
   The steam circulates in pipe to goes turns turbine to create electricity.
B—(2) storage, the water from the storage to go to the boiler, do not need the pump, do not need high pressure, It is done in a way that circulates water in the house. certain pipe sizes reduced and certain wide.
   The recovered steam goes to storage (water tank 2) then goes to storage (water tank 1) and returns to the boiler.
C—The battery powered to boiler water to become steam, there is autonomy for 8 to 12 hours, a small 000.1% electricity from turbine will charge the battery, battery energy does not end.
D—Step down transformed.

Transformed it reduces voltage for the device charger, within other connect send to high voltage line.

3—the Drawing with 10 Turbines, or 100 Turbine the Number is not the Limit, System Calculates was by Steam Pressure from Boiler.

The turbine-generator, boiler they are inside large warehouse, 2 tank water outside of warehouse.
10 Turbines Generator
45% Turbine=electricity capacity 120 MW (Mega Watt)
90% Turbine=electricity capacity 240 MW (Mega Watt)

Each turbine has an electricity capacity control system.
A—The Boiler Water becomes steam.
   The steam circulates in pipe to goes turns turbine (Steam go in A and out, EX)
      You have 2 pipe which does not link and not connect
         A pipe of boiler go turn the Turbine.
         EX, pipe of steam out from turbine goes Water tank 2.

Water Tank 1, Storage water capacity 500 thousand liters, (500, K, L) send water to boiler. The water from the storage to go to the boiler, do not need the pump, do not need high pressure.

Water tank 2, the recovered steam change to water, then goes to storage Water Tank1
C—The battery 1.1 MWh powered to boiler water to become steam, there is autonomy for 10 to 15 hours, a small 000000.1% electricity from turbine will charge the battery, battery energy does not end.
D—Step down Transformed by number at 2. (SDT1) and (SDT 2)

The generating step-up transformer to transmission lines, then connects an electrical power distribution, a connects many substations step-down transformers among which one connected reduces high voltage, recharge the device.

1. My invention Dobymy Power Plant, the battery operates to boiler, Water goes into boiler to become steam, boiler creates steam with water, or liquid transformable to steam, sea water, or river, or non-potable water, example taking water from the sea we create electricity then to consume it water.
My boiler I give the name of Tarso Kinimi (small volcano), consumes little energy but it's very powerful which will transform the water into steam in a few seconds my battery is very powerful, and light, does not heat up, code name 1 duna=1 million duna.
I will file 2 patent applications for the boiler and the battery in future.
My invention same operation of the nuclear power plant, instead of the nuclear fuel, I put the battery, the nuclear power plant functions large turbine, in my invention I put small turbine, I increase the number of the turbine I create much electricity, with my invention will by create at one place put 3 nuclear power plant capacity.
My invention Dobymy Power Plant, created 100% green energies, to which is added MWD power unit (Mega Watt Dobymy), and Watt Dobymy hour. (WDH).
My invention Dobymy Power Plant is not dangerous, it does not exploit either, 100% security and safety it is good for the environment, is cheaper and sustainability.
My invention Dobymy Power Plant very easy to doing electricity everywhere in the world and in space, on moon and mars.
My invention Dobymy Power plant creates autonomous owned electricity 100% Green and very cheap electricity, for big City like New York city or Chicago, no need Electric lines (power high transmission) come from power plant at 200 miles or 2000 miles, my invention very good for environment.
Mobility Dobymy Power plant which creates its own energy, Dobymy E-car, Dobymy E-Truck, Dobymy E-Train, Dobymy E-boat or Ship, DobymyAircraft carrier, Dobymy drone, Dobymy aircraft, Dobymy submarine, Dobymy subway, all types of agricultural vehicles, or construction.
Not Mobility Dobymy Power plant which creates its own energy, Dobymy house, Dobymy warehouse, Dobymy factory, Dobymy small and big city, Dobymy manufacturing of green hydrogen, Dobymy Oil refinery.
